(19) United States
(12) Patent Application Publication
(10) Pub. No.: US 2026/0107161 A1
(43) Pub. Date: Apr. 16, 2026

(54) CONFLICT MANAGEMENT IN O-RAN

(71) Applicant: QUALCOMM Incorporated, San Diego, CA (US)

(72) Inventors: Rajeev KUMAR, Bangalore (IN); Geetha Priya RAJENDRAN, Bangalore (IN); Satashu GOEL, San Diego, CA (US)

(21) Appl. No.: 18/912,054

(22) Filed: Oct. 10, 2024

(51) Int. Cl. H04W 24/04

(52) U.S. Cl. CPC H04W 24/04

(57) ABSTRACT

Apparatus, methods, and computer program products for wireless communication are provided. An example method may include detecting, at a session management and orchestration (SMO), a trigger for conflict management associated with at least one application. The example method may further include providing, at the SMO based on the trigger for the conflict management, a conflict evaluation or a conflict mitigation.

### TECHNICAL FIELD

The present disclosure relates generally to communication systems, and more particularly, to wireless communication systems with session management and orchestration (SMO) that may resolve conflict for application(s).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In another aspect of the disclosure, a method, a computer-readable medium, and an apparatus at a network entity are provided. The apparatus may include at least one memory and at least one processor coupled to the at least one memory. Based at least in part on information stored in the at least one memory, the at least one processor, individually or in any combination, is configured to detect, at a session management and orchestration (SMO), a trigger for conflict management associated with at least one application. Based at least in part on information stored in the at least one memory, the at least one processor, individually or in any combination, is configured to provide, at the SMO based on the trigger for the conflict management, a conflict evaluation or a conflict mitigation.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example architecture for session management and orchestration (SMO), in accordance with various aspects of the present disclosure.

FIG. 5 is a diagram illustrating an example architecture for a near-real time radio access network intelligent controller (near-RT RIC) platform, in accordance with various aspects of the present disclosure.

FIG. 6 is a diagram illustrating an example architecture for conflict management in SMO, in accordance with various aspects of the present disclosure.

FIG. 7 is another diagram illustrating an example architecture for conflict management in SMO, in accordance with various aspects of the present disclosure.

FIG. 8 is a diagram illustrating an example architecture for conflict management based on centralized conflict management, in accordance with various aspects of the present disclosure.

FIG. 9 is a diagram illustrating an example architecture for conflict management based on conflict management via rApps (non-real-time RIC application), in accordance with various aspects of the present disclosure.

FIG. 10 is a diagram illustrating an example architecture for conflict management based on distributed framework, in accordance with various aspects of the present disclosure.

FIG. 11 is a diagram illustrating example communications between a centralized entity, a distributed entity, and one or more applications, in accordance with various aspects of the present disclosure.

FIG. 12 is a diagram illustrating example communications between a centralized entity, a distributed entity, and one or more applications, in accordance with various aspects of the present disclosure.

FIG. 13 is a diagram illustrating example communications between a centralized entity, a distributed entity, and one or more applications, in accordance with various aspects of the present disclosure.

FIG. 14 is a diagram illustrating example communications between a centralized entity, a distributed entity, and one or more applications, in accordance with various aspects of the present disclosure.

FIG. 15 is a flowchart of a method of wireless communication, in accordance with various aspects of the present disclosure.

FIG. 16 is a diagram illustrating an example of a hardware implementation for a network entity, in accordance with various aspects of the present disclosure.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Aspects provided herein provides architectures where the session management and orchestration (SMO) provides the functionalities of conflict evaluation/detection or conflict mitigation/guidance based on digital twin (DT) or non-DT, which may enable conflicts to be more efficiently resolved for various applications.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof. One or more processors in the processing system may execute software to cause a device that includes the one or more processors to perform the various functionality described throughout this disclosure.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer (e.g., transitory or non-transitory medium that may be accessed by computer).

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

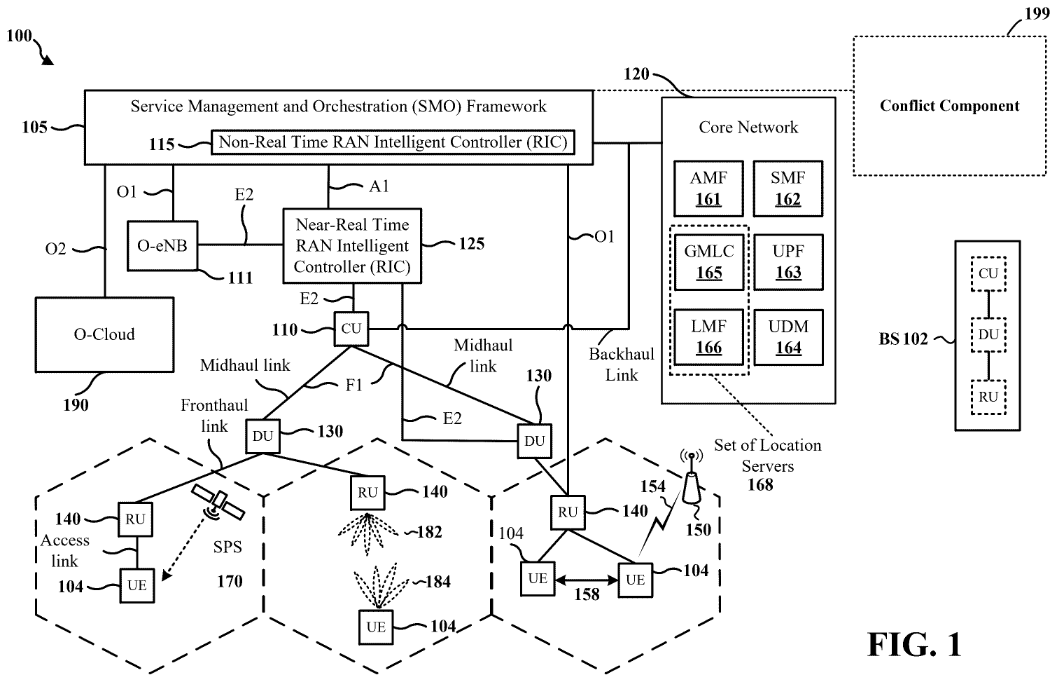

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units.

Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

In some aspects, the SMO 105 may include a conflict component 199. In some aspects, the conflict component 199 may be configured to detect, at a session management and orchestration (SMO), a trigger for conflict management associated with at least one application. In some aspects, the conflict component 199 may be further configured to provide, at the SMO based on the trigger for the conflict management, a conflict evaluation or a conflict mitigation.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

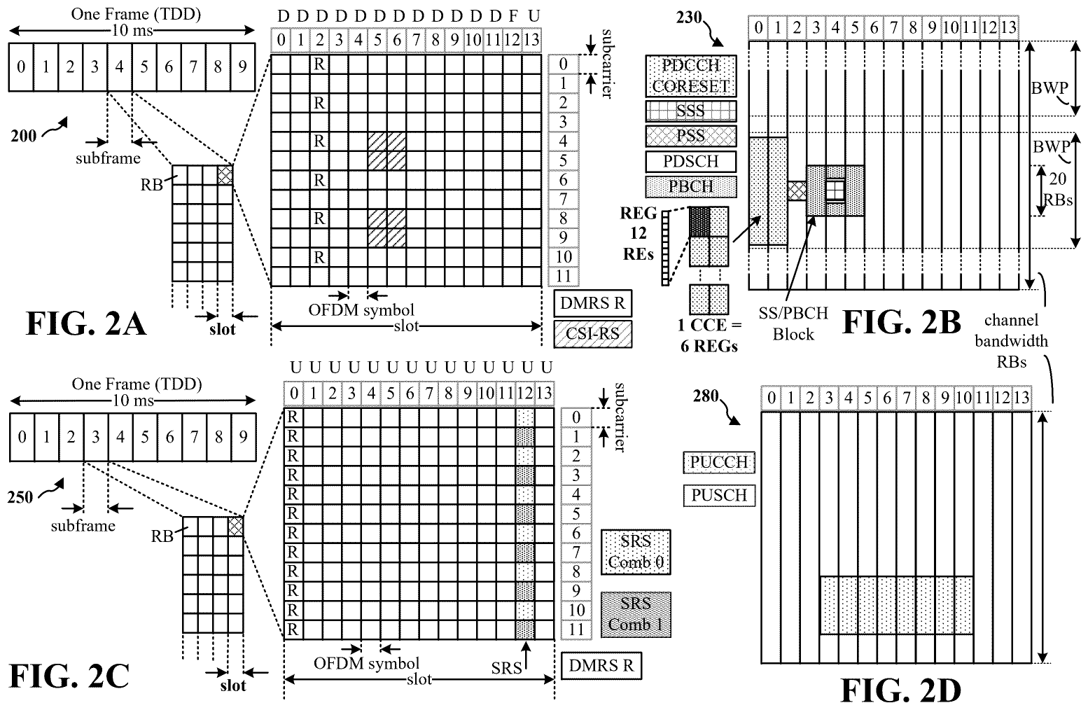

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

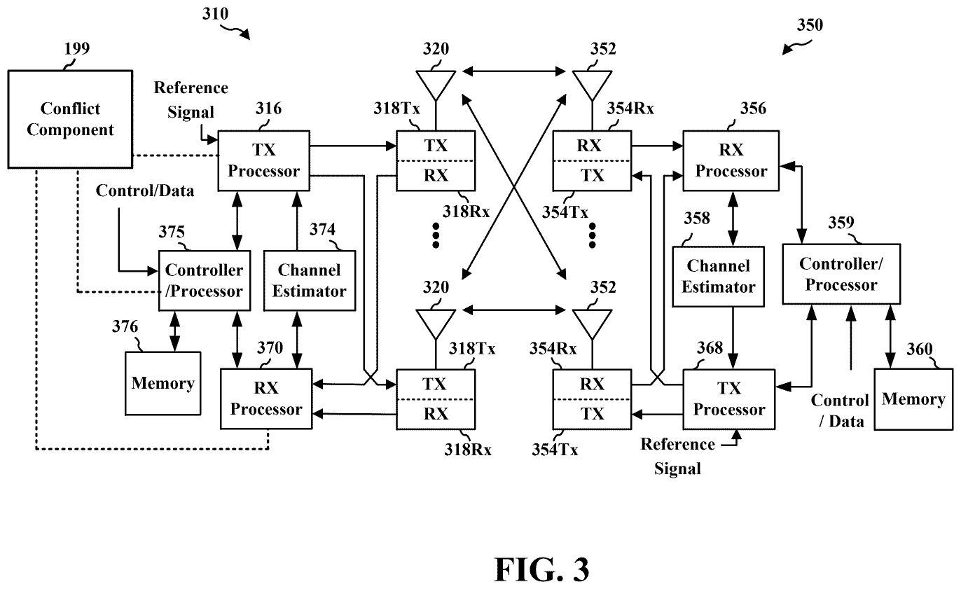

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 316, the RX processor 370, and the controller/processor 375 may be configured to perform aspects in connection with conflict component 199 of FIG. 1.

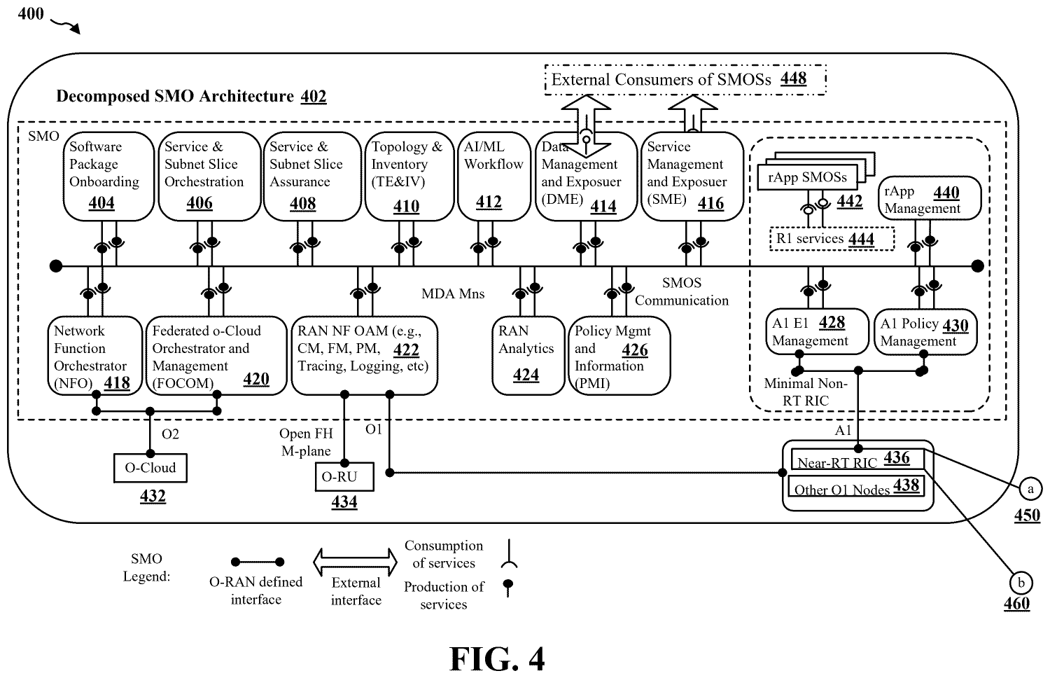

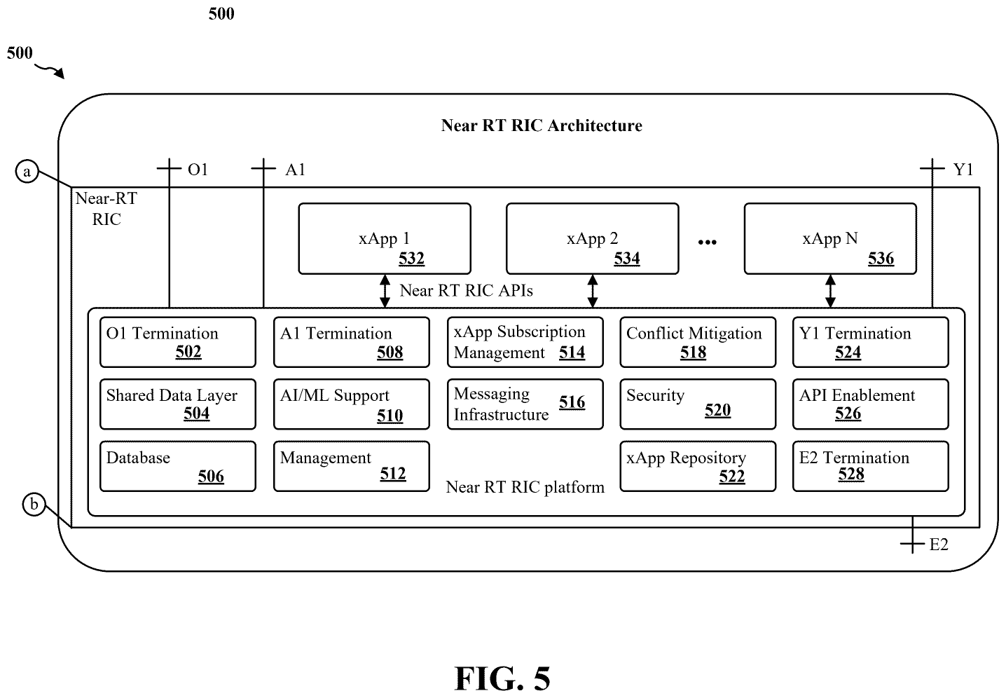

In some wireless communication systems, conflict mitigation or conflict evaluation of different applications, such as near-real-time RIC application (xApp) or non-real-time RIC application (rApp) are not provided by an SMO but rather a near-real time radio access network intelligent controller (near-RT RIC) platform. FIG. 4 is a diagram 400 illustrating an example architecture for session management and orchestration (SMO), in accordance with various aspects of the present disclosure. As illustrated in FIG. 4, in a decomposed SMO structure 402, in some aspects, there may be a software package onboarding function 404 (e.g., configured to handle onboarding and managing software packages for various network functions), a service & subnet slice orchestration function 406 (e.g., configured to manage network slicing, a technique used to partition resources for different services, ensuring efficient and isolated service management), a service & subnet slice assurance function 408 (e.g., configured to monitors the performance of the network slices, ensuring they meet service levels and key performance metrics (KPIs)), and a topology & inventory 410 (e.g., configured to keep track of network topology, assets, and inventory management). For handling artificial intelligence/machine learning (AI/ML), there may be AI/ML workflow function 412 (e.g., configured to implement AI/ML algorithms to automate processes such as anomaly detection, resource optimization, and predictive maintenance). For data management and exposure (DME), the SMO may also include a DME function 414 (e.g., configured to manage network data collection and its exposure to external consumers 448). For service management and exposure (SME), the SMO may also include a SME function 416 (e.g., configured to expose services for third-party consumers and allows for service management via interfaces). The SMO may also include a network function orchestrator (NFO) 418 (e.g., configured to automate the deployment, configuration, and lifecycle management of network functions within the SMO framework), a federated O-cloud orchestration and management (FOCOM) function 420 (e.g., configured to coordinate multiple O-cloud environments which enables federated orchestration of resources across various cloud infrastructures, such as O-cloud 432), a RAN NF OAM 422 (operations, administration, maintenance) for the management of network functions in the radio access network, such as configuration management (CM), fault management (FM), performance management (PM), and logging/tracing, a RAN analytics function 424 responsible for collecting, analyzing, and processing data from the RAN (e.g., RU 434), and a policy management and information (PMI) function 426 configured to defines policies that guide network management actions and behavior (e.g., based on real-time data and analytics). The illustrated SMO may further include an rApp management 440 configured to manage rApps, and an rApp SMOs 442 configured to process (1) the deployment, updates, scaling, and termination of rApps, (2) enforce policy of rApps, (3) facilitate communication between rApps and other elements in the network, and (4) and manage resource allocation for rApps. The illustrated SMO may further include R1 services 444 for enabling rApps to interacting with the SMO platform and other network elements, such as A1 E1 Management 428 and A1 policy management 430 for sending enhanced information to the near-RT RIC 436 and managing policies related to the A1 interface between the SMO and the near-RT RIC 436. The near-RT RIC 436 (may also be referred to as a near-RT RIC platform) may be in communication, along with other O1 nodes 438, with the RAN NF OAM 422. Structure of the near-RT RIC 436 may be further described in 450 and structure of the other O1 nodes 438 may be further described in 460, which continue in FIG. 5.

FIG. 5 is a diagram 500 illustrating an example architecture for a near-RT RIC platform, in accordance with various aspects of the present disclosure. As illustrated in FIG. 5, within the near-RT RIC platform, there may be a set of xApps including xApp 1 532, xApp 2 534, . . . xApp N 536. The near-RT RIC platform may also include an O1 termination function 502 and an A1 termination function 508 that manage termination of O1/A1 interfaces. The near-RT RIC platform may also include a shared data layer 504, which is a central repository for data shared among different xApps and functions. The near-RT RIC platform may also include a database 506. The near-RT RIC platform may also include an AI/ML support function 510 that provides support for AI and ML operations within the near-RT RIC. The near-RT RIC platform may also include a management function 512.

The near-RT RIC platform may also include an xApp subscription management function 514 for managing subscriptions between xApps and the network elements or data sources they interact with. The near-RT RIC platform may also include a messaging infrastructure 516 for enabling messaging between xApps and other components. The near-RT RIC platform may also include a conflict mitigation function 518 for handling conflict resolution between xApps or tasks in real-time. The near-RT RIC platform may also include a security function 520. The near-RT RIC platform may also include an xApp repository 522 for storage and management of xApps. The near-RT RIC platform may also include Y1 termination 524, API enablement 526, and E2 termination 528 for managing various interfaces for external communications (e.g., management plane, real-time control plane, and other signaling).

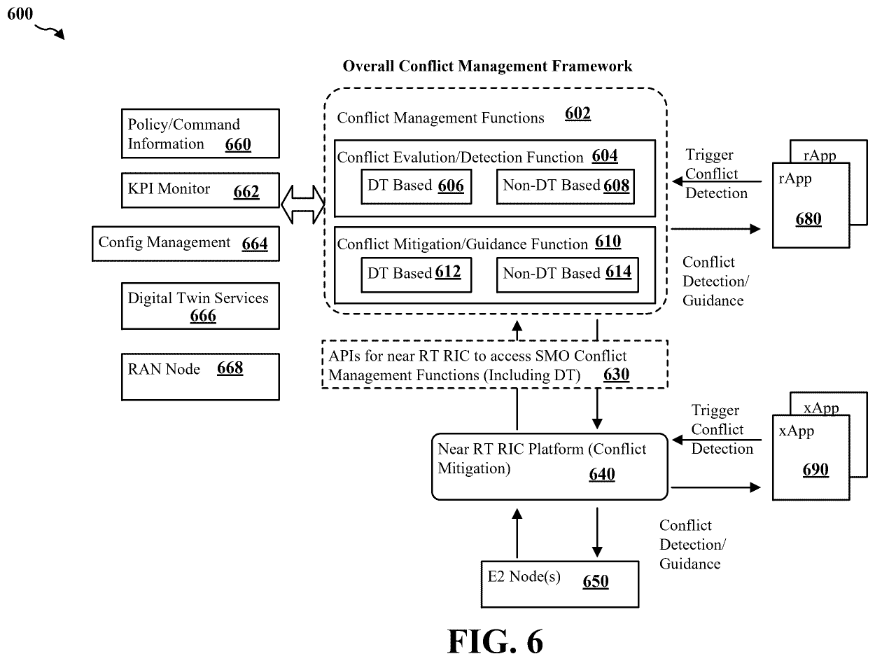

Aspects provided herein provides architectures where the session management and orchestration (SMO) provides the functionalities of conflict evaluation/detection or conflict mitigation/guidance based on digital twin (DT) or non-DT, which may enable conflicts to be more efficiently resolved for various applications. FIG. 6 is a diagram 600 illustrating an example architecture for conflict management in SMO, in accordance with various aspects of the present disclosure.

In the SMO, there may be a conflict management function 602 that includes a conflict evaluation/detection function 604, which may be DT based 606 (e.g., based on DTs of the applications and their associated environment, which includes simulations of the applications with respect to different current or candidate policies or configurations, and provided by DT services 666) or non-DT based 608 (e.g., rule based, past learning, AI/ML models, or other non-simulation based evaluations). The conflict evaluation/detection function 604 may provide support for detecting all types of policy/configuration conflicts (direct, Indirect, Implicit). Consumers of this functionality (e.g., rApp 680, KPI monitor 662, configuration management 664, or policy/command information 660, RAN node 668) may trigger conflict detection by providing the information about policies/configurations to be evaluated for conflict. The conflict mitigation/guidance function 610 may also be DT based 612 or non-DT based 614. The conflict mitigation/guidance function 610 may support creating conflict resolution actions for all types of policy/configuration conflicts (direct, indirect, implicit). The conflict mitigation/guidance function 610 may support two modes: (1) autonomous mitigation where conflict resolution actions are directly deployed by suspending/aborting certain policies/configurations, or (2) guidance where Conflict resolution action options are provided to the consumer (e.g., network operations & management) of the service; enforcement of the guidance is not in the scope of the function conflict mitigation/guidance function 610. Consumers of this functionality can trigger conflict mitigation by providing the information about the policies/configurations to be evaluated for mitigation. Via APIs 630, the conflict management functions 602 may be in communication with near RT RIC platform 640, which may receive trigger conflict guidance from the xApps 690 or provide conflict detection/guidance generated by the conflict management functions 602 to the xApps 690. The near RT RIC platform 640 may also be in communication with E2 node(s) 650.

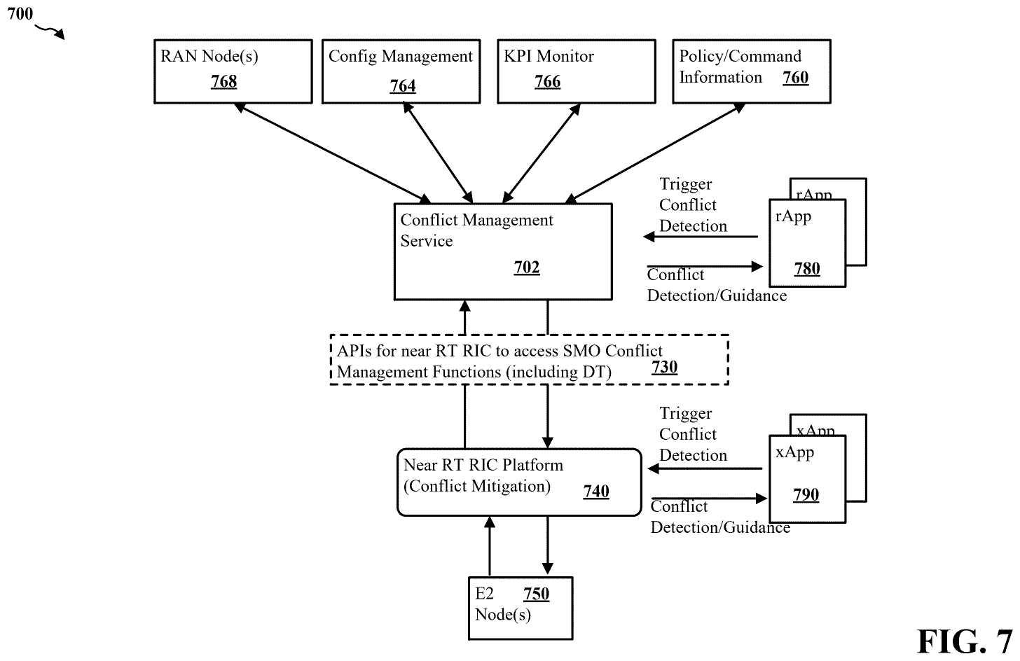

FIG. 7 is another diagram 700 illustrating an example architecture for conflict management in SMO, in accordance with various aspects of the present disclosure. As illustrated in FIG. 7, conflict management service 702 may be in communication with (interact with) RAN node(s) 768, configuration management 764 (e.g., to activates conflict management service proactively before deploying a new/modified configuration), KPI monitor 766 (to track the KPIs/Faults data corresponding to a policy/configuration expectation and trigger conflict evaluation if the monitored information breaches one or more set expectations), rApps 780 (e.g., to activate conflict management service either proactively before deploying a new/modified policy/configuration, or reactively when it observes degradation in KPIs), and policy/command information 760. Via APIs 730, the conflict management service 702 may be in communication with near RT RIC platform 740, which may receive trigger conflict guidance from the xApps 790 or provide conflict detection/guidance generated by the conflict management service 702 to the xApps 790. The near RT RIC platform 740 may also be in communication with E2 node(s) 750. Conflict detection by the conflict management service 702 can be proactive (e.g., before the policy/command is enforced for the application) or reactive (e.g., after the policy/command is enforced and impacts KPIs). For xApps 790 and the near RT RIC platform 740, conflict detection and mitigation among xApps may be handled by conflict mitigation functionality within near-RT RIC platform functions (referred to as “nearRtRicConflictMitFn”). In scenarios where nearRtRicConflictMitFn is not able to detect/mitigate conflict between xApps, it can activate conflict management service 702 from SMO providing used configuration information about xApps. Alternatively, if conflict management service 702 in SMO is activated by KPI monitoring, it may request nearRtRicConflictMitFn for configuration information about xApps (e.g., for the case where a xApp configuration conflicts with some rApp policy/configuration).

Example triggers for conflict management are provided in table 2 below:

TABLE 2

| Event | Action | Note |
|---|---|---|
| App registration | Update DB with App | App information like Intent(use- |
| | description | case), Objective(measured |
| | | parameters), Scope, or the like, |
| | | are added |
| App deregistration | Update DB with App | App information removed |
| | description | |
| App Initiated | Conflict evaluation. | Evaluating if proposed |
| Conflict Evaluation | Recommendation for App | configuration change by |
| | in response. | requesting App impacts existing |
| | | KPIs corresponding to prior |
| | | configurations. |
| Monitor Initiated | Conflict evaluation. | Triggered when |
| Conflict Evaluation | Recommendation for App | performance/fault data indicates |
| | in response. | deviation from expectation, |
| | | correlated to any recent |
| | | Operator/App based |
| | | configuration change. |

Scenarios which use DT simulations for conflict detection are provided below:

TABLE 3

| | Direct Conflict | Indirect Conflict | Implicit Conflict |
|---|---|---|---|
| Pre Policy/ | Not use | If past knowledge | If past knowledge |
| Configuration | | is not sufficient | is not sufficient |
| Activation | | | |
| Post Policy/ | NA (may be taken | If pre-activation | If pre-activation |
| Configuration | care as part of | check did not detect | check did not |
| Activation | conflict avoidance) | or check was not | detect or check |
| | | performed | was not performed |

DT may be used for assessing the impact of conflicting configurations on KPIs and may be used to backtrack activation of ongoing configurations/policies to find acceptable configuration.

Conflict detection may be done based on a variety of options, that may be standalone options or combined. In a first option, conflict detection may be based on running iterative simulations using DT with configuration of N^{th} policy against N−1 policies until a conflict is detected. In a second option, conflict detection may be based on an algorithm which chooses conflicting policies from the policy database using information provided by consumers and runs DT based simulations with the configurations of the selected policies to detect conflict. In a third option, conflict detection may be based on rule based detection. Information provided by consumers may include policy category (intent/use case), policy status (enforced or not enforced), policy priority, application identifier (ID) which enforced or intends to enforce the policy, information on KPI degradation, or the like. Detection of conflicting policies may be based on the rules specified in operator configuration.

Conflict Mitigation may be done based on identification of conflicting policy/configuration. Conflict management service may identify the conflicting configuration based on the options for conflict detection. Conflict management service may identify corresponding policy (if any) from the policy management database which enforced the configuration. The conflict management service may perform mitigation action plan generation. For example, if more than one policy/configuration causes conflict, the conflict management service may generate (e.g., using DT service) alternatives of policies/configurations which can be impacted to resolve conflict.

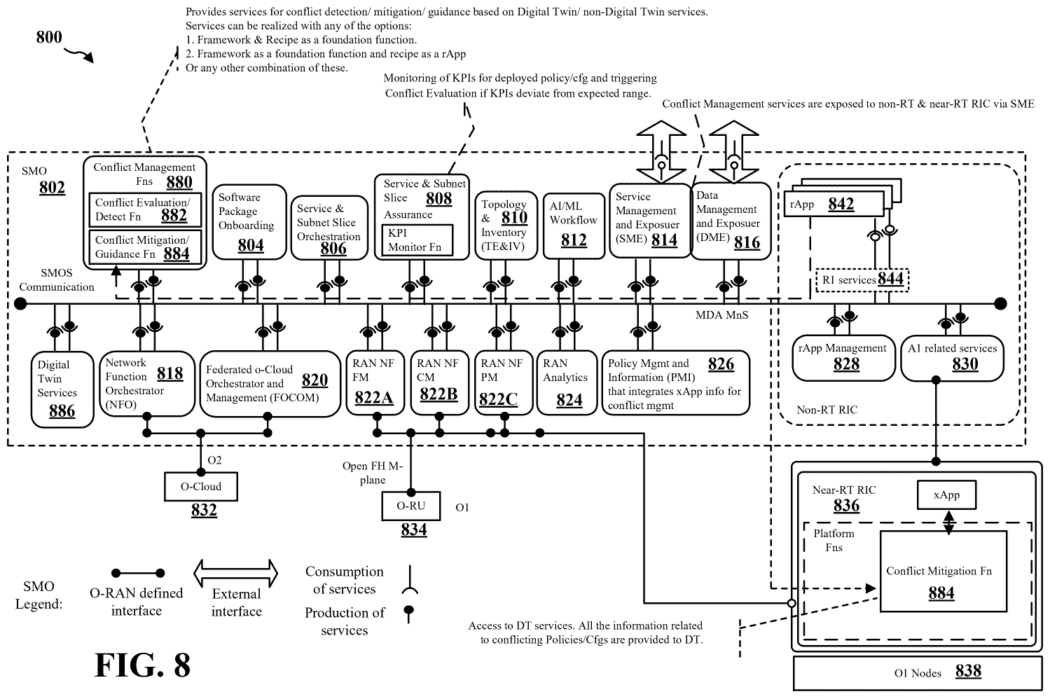

FIG. 8 is a diagram 800 illustrating an example architecture for conflict management based on centralized conflict management, in accordance with various aspects of the present disclosure. As illustrated in FIG. 8, in an SMO 802, in some aspects, there may be a software package onboarding function 804 (e.g., configured to handle onboarding and managing software packages for various network functions), a service & subnet slice orchestration function 806 (e.g., configured to manage network slicing, a technique used to partition resources for different services, ensuring efficient and isolated service management), a service & subnet slice assurance function 808 (e.g., configured to monitors the performance of the network slices, ensuring they meet service levels and KPIs), and a topology & inventory 810 (e.g., configured to keep track of network topology, assets, and inventory management). For handling artificial AI/ML, there may be AI/ML workflow function 812 (e.g., configured to implement AI/ML algorithms to automate processes such as anomaly detection, resource optimization, and predictive maintenance). For DME, the SMO 802 may also include a DME function 816 (e.g., configured to manage network data collection and its exposure to external consumers). For SME, the SMO 802 may also include a SME function 814 (e.g., configured to expose services for third-party consumers and allows for service management via interfaces). The SMO may also include a network function orchestrator (NFO) 818 (e.g., configured to automate the deployment, configuration, and lifecycle management of network functions within the SMO framework), a FOCOM function 820 (e.g., configured to coordinate multiple O-cloud environments which enables federated orchestration of resources across various cloud infrastructures, such as O-cloud 832), a RAN NF OAM (operations, administration, maintenance) for the management of network functions in the radio access network, such as CM 822B, FM 822A, PM 822C, and logging/tracing, a RAN analytics function 824 responsible for collecting, analyzing, and processing data from the RAN (e.g., RU 834), and a PMI function 826 configured to defines policies that guide network management actions and behavior (e.g., based on real-time data and analytics). The illustrated SMO may further include an rApp management 828 configured to manage rApps, and an rApp SMOs 842 configured to process (1) the deployment, updates, scaling, and termination of rApps, (2) enforce policy of rApps, (3) facilitate communication between rApps and other elements in the network, and (4) and manage resource allocation for rApps. The illustrated SMO 802 may further include RI services 844 for enabling rApps to interacting with the SMO platform and other network elements, such as A1 related services 830 for sending enhanced information to the near-RT RIC 836 and managing policies related to the A1 interface between the SMO and the near-RT RIC 836. The near-RT RIC 836 (may also be referred to as a near-RT RIC platform) may be in communication, along with other O1 nodes 838, with the RAN NF OAM.

In the example illustrated in FIG. 8, conflict management functions are mapped into SMO architecture as framework for collecting information about Apps that re-uses PMI for all registered policy & configurations. Functionality for integrating xApp generated configuration info into centralized system, in-case the conflict is due to xApps. Algorithm/recipe for detecting/mitigating conflict and/or generating guidance are added as foundation functions of SMO. A conflict management function 880, which includes conflict evaluation function 882 and conflict mitigation function 884 (which may also be referred to as a conflict mitigation/guidance function), are included. The conflict management function 880 may provide services for conflict detection/mitigation/guidance based on digital twin (enabled by digital twin services 886) or non-digital twin services. The conflict management function 880 may be implemented based on: (1) framework and recipe as a foundation function, or (2) framework as a foundation function and recipe as a rApp. The service & subnet slice assurance function 808 may include KPI monitoring function responsible for monitoring of KPIs for deployed policy/configuration and triggering conflict evaluation if KPIs deviate from expected range. Conflict management services may be exposed to non-RT & near-RT RIC (e.g., 836) via the SME function 814. The near-RT RIC 836 may include conflict mitigation function 884.

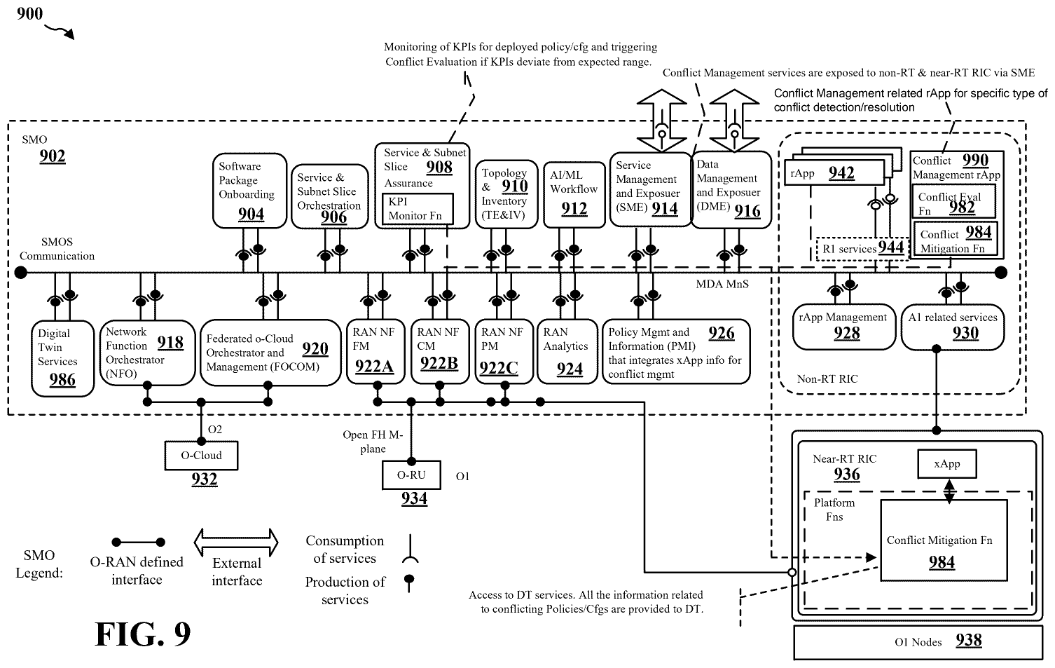

FIG. 9 is a diagram 900 illustrating an example architecture for conflict management based on conflict management via rApps (non-real-time RIC application), in accordance with various aspects of the present disclosure. As illustrated in FIG. 9, in an SMO 902, in some aspects, there may be a software package onboarding function 904 (e.g., configured to handle onboarding and managing software packages for various network functions), a service & subnet slice orchestration function 906 (e.g., configured to manage network slicing, a technique used to partition resources for different services, ensuring efficient and isolated service management), a service & subnet slice assurance function 908 (e.g., configured to monitors the performance of the network slices, ensuring they meet service levels and KPIs), and a topology & inventory 910 (e.g., configured to keep track of network topology, assets, and inventory management). For handling artificial AI/ML, there may be AI/ML workflow function 912 (e.g., configured to implement AI/ML algorithms to automate processes such as anomaly detection, resource optimization, and predictive maintenance). For DME, the SMO 902 may also include a DME function 916 (e.g., configured to manage network data collection and its exposure to external consumers). For SME, the SMO 902 may also include a SME function 914 (e.g., configured to expose services for third-party consumers and allows for service management via interfaces). The SMO may also include a network function orchestrator (NFO) 918 (e.g., configured to automate the deployment, configuration, and lifecycle management of network functions within the SMO framework), a FOCOM function 920 (e.g., configured to coordinate multiple O-cloud environments which enables federated orchestration of resources across various cloud infrastructures, such as O-cloud 932), a RAN NF OAM (operations, administration, maintenance) for the management of network functions in the radio access network, such as CM 922B, FM 922A, PM 922C, and logging/tracing, a RAN analytics function 924 responsible for collecting, analyzing, and processing data from the RAN (e.g., RU 934), and a PMI function 926 configured to defines policies that guide network management actions and behavior (e.g., based on real-time data and analytics). The illustrated SMO may further include an rApp management 928 configured to manage rApps, and an rApp SMOs 942 configured to process (1) the deployment, updates, scaling, and termination of rApps, (2) enforce policy of rApps, (3) facilitate communication between rApps and other elements in the network, and (4) and manage resource allocation for rApps. The illustrated SMO 902 may further include RI services 944 for enabling rApps to interacting with the SMO platform and other network elements, such as A1 related services 930 for sending enhanced information to the near-RT RIC 936 and managing policies related to the A1 interface between the SMO and the near-RT RIC 936. The near-RT RIC 936 (may also be referred to as a near-RT RIC platform) may be in communication, along with other O1 nodes 938, with the RAN NF OAM.

In the example illustrated in FIG. 9, the conflict management functions are mapped into SMO architecture as framework for collecting information about Apps and re-uses PMI for all registered policy & configurations. Functionality for integrating xApp generated configuration info into centralized system, in-case the conflict is due to xApps. Algorithm/recipe for detecting/mitigating conflict and/or generating guidance are added as rApps related to conflict management. As illustrated in FIG. 9, conflict management rApp 990 includes conflict evaluation function 982 and conflict mitigation function 984, which may be DT based (enabled by digital twin services 986) or non-DT based. The conflict management rApp 990 may provide service for conflict management related rApp for specific type(s) of conflict detection/resolution. The conflict Management services provided by the conflict management rApp 990 may be exposed to non-RT & near-RT RIC via SME function 914. The service & subnet slice assurance function 908 may include KPI monitoring function responsible for monitoring of KPIs for deployed policy/configuration and triggering conflict evaluation if KPIs deviate from expected range.

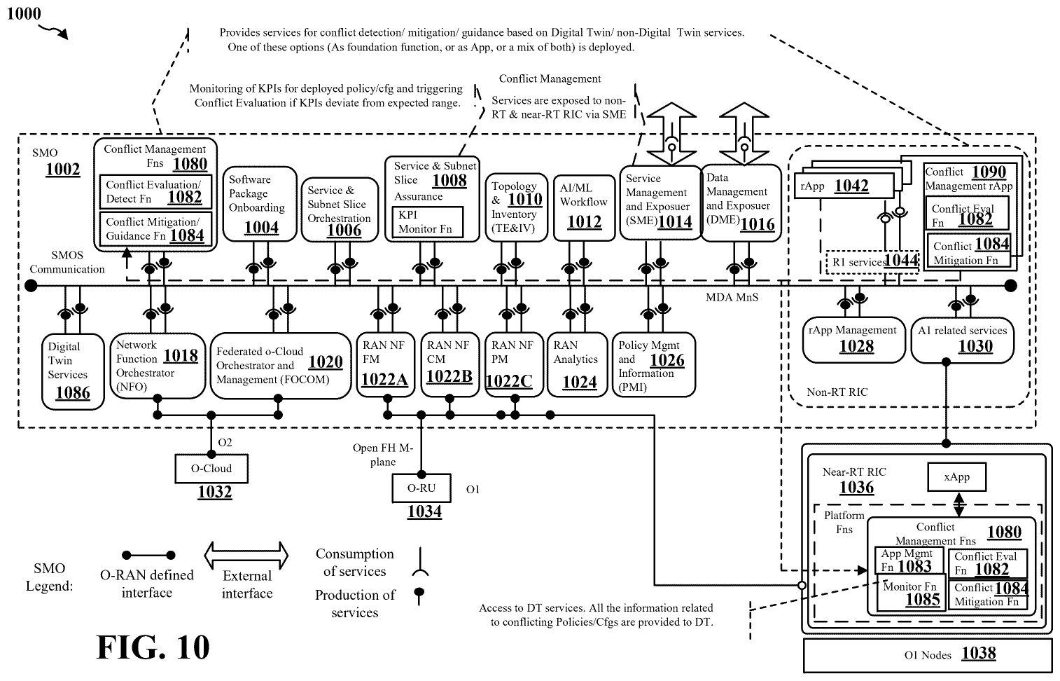

FIG. 10 is a diagram 1000 illustrating an example architecture for conflict management based on distributed framework, in accordance with various aspects of the present disclosure.

As illustrated in FIG. 10, in an SMO 1002, in some aspects, there may be a software package onboarding function 1004 (e.g., configured to handle onboarding and managing software packages for various network functions), a service & subnet slice orchestration function 1006 (e.g., configured to manage network slicing, a technique used to partition resources for different services, ensuring efficient and isolated service management), a service & subnet slice assurance function 1008 (e.g., configured to monitors the performance of the network slices, ensuring they meet service levels and KPIs), and a topology & inventory 1010 (e.g., configured to keep track of network topology, assets, and inventory management). For handling artificial AI/ML, there may be AI/ML workflow function 1012 (e.g., configured to implement AI/ML algorithms to automate processes such as anomaly detection, resource optimization, and predictive maintenance). For DME, the SMO 1002 may also include a DME function 1016 (e.g., configured to manage network data collection and its exposure to external consumers). For SME, the SMO 1002 may also include a SME function 1014 (e.g., configured to expose services for third-party consumers and allows for service management via interfaces). The SMO may also include a network function orchestrator (NFO) 1018 (e.g., configured to automate the deployment, configuration, and lifecycle management of network functions within the SMO framework), a FOCOM function 1020 (e.g., configured to coordinate multiple O-cloud environments which enables federated orchestration of resources across various cloud infrastructures, such as O-cloud 1032), a RAN NF OAM (operations, administration, maintenance) for the management of network functions in the radio access network, such as CM 1022B, FM 1022A, PM 1022C, and logging/tracing, a RAN analytics function 1024 responsible for collecting, analyzing, and processing data from the RAN (e.g., RU 1034), and a PMI function 1026 configured to defines policies that guide network management actions and behavior (e.g., based on real-time data and analytics). The illustrated SMO may further include an rApp management 1028 configured to manage rApps, and an rApp SMOs 1042 configured to process (1) the deployment, updates, scaling, and termination of rApps, (2) enforce policy of rApps, (3) facilitate communication between rApps and other elements in the network, and (4) and manage resource allocation for rApps. The illustrated SMO 1002 may further include RI services 1044 for enabling rApps to interacting with the SMO platform and other network elements, such as A1 related services 1030 for sending enhanced information to the near-RT RIC 1036 and managing policies related to the A1 interface between the SMO and the near-RT RIC 1036. The near-RT RIC 1036 (may also be referred to as a near-RT RIC platform) may be in communication, along with other O1 nodes 1038, with the RAN NF OAM.

In the example illustrated in FIG. 10, the conflict management functions are mapped into SMO architecture as Framework for collecting information about Apps that uses PMI for all registered policy & configurations. Functionality for interaction between SMO conflict management functionality and near-RT RIC conflict mitigation (nearRtRicConflictMitFn) for running conflict detection and mitigation using digital twin, in-case nearRtRicConflictMitFn is not able to resolve conflict, or SMO conflict management suspects xApps to be cause of conflict. Algorithm/recipe for detecting/mitigating conflict and/or generating guidance are added either as foundation functions of SMO, or rApps. In some aspects, a conflict management function 1080, which includes conflict evaluation function 1082 and conflict mitigation function 1084 (which may also be referred to as a conflict mitigation/guidance function), are included. The conflict management function 880 may provide services for conflict detection/mitigation/guidance based on digital twin (enabled by digital twin services 1086) or non-digital twin services. The conflict management function 1080 may be implemented based on: (1) framework and recipe as a foundation function, or (2) framework as a foundation function and recipe as a rApp. The service & subnet slice assurance function 1008 may include KPI monitoring function responsible for monitoring of KPIs for deployed policy/configuration and triggering conflict evaluation if KPIs deviate from expected range. Conflict management services may be exposed to non-RT & near-RT RIC (e.g., 1036) via the SME function 1014. The near-RT RIC 1036 may include conflict management function 1080, which includes conflict mitigation function 1084, conflict evaluation function 1082, App management 1083, and monitoring function 1085. In some aspects, conflict management rAPP 1090 which includes conflict evaluation function 1082 and conflict mitigation function 1084, which may be DT based (enabled by digital twin services 1086) or non-DT based, may be included. The conflict management rAPP 1090 may provide service for conflict management related rApp for specific type(s) of conflict detection/resolution. The conflict Management services provided by the conflict management rAPP 1090 may be exposed to non-RT & near-RT RIC via the SME function 1014.

In some aspects, conflict management offers services for detection/mitigation/guidance (avoidance). The services may be offered from a central conflict management entity or through an architecture of distributed conflict management entities. In some aspects, used policy/configuration/App information/mitigation actions are provided in services/APIs between central and distributed entities. In some aspects, conflict management functions in SMO are mapped to central entity. In some aspects, conflict management functions in RAN/near-RT RIC are mapped to distributed entity.

In some aspects, conflict management in SMO for can expose the following services: (1) service (API) to request for conflict detection that takes input in the form of (A) use-case or RRM functionality (e.g., load balancing, mobility management, UE context management, or the like), (B) degraded KPIs, (C) possible conflicting policies information from distributed entities (e.g., conflict management in near-RT RIC/RAN), and (D) new policy information, and outputs conflicting Policy information or conflicting policy actions with impacted parameters and values (e.g., conflicting policy trigger conditions with impacted parameters and values or xApp/rApp information which deployed that policy), and (2) service (API) to request for conflict mitigation which may take same/similar input as the service (API) to request for conflict detection and output conflicting policies information and (A) action to deactivate/activate a policy or (B) guidance on possible modifications to a conflicting policy to avoid conflicts for applications such as xApp/rApp.

In some aspects, conflict mitigation in SMO for can expose the following services: (1) services (API) to provide policies which takes use-case or RRM functionality (e.g., load balancing, mobility management, UE context management, or the like) or degraded KPIs as input and outputs policy information, state of the policy (deployed/not deployed), xApp information which deployed that policy, policy trigger condition parameters and its values, or policy action parameters and its values, and (2) services (API) to receive conflict detection and mitigation which takes information on conflicting policy, action to deactivate/activate a policy, or guidance on possible modifications to a policy to avoid conflicts as input and outputs ACK/NACK of mitigation action.

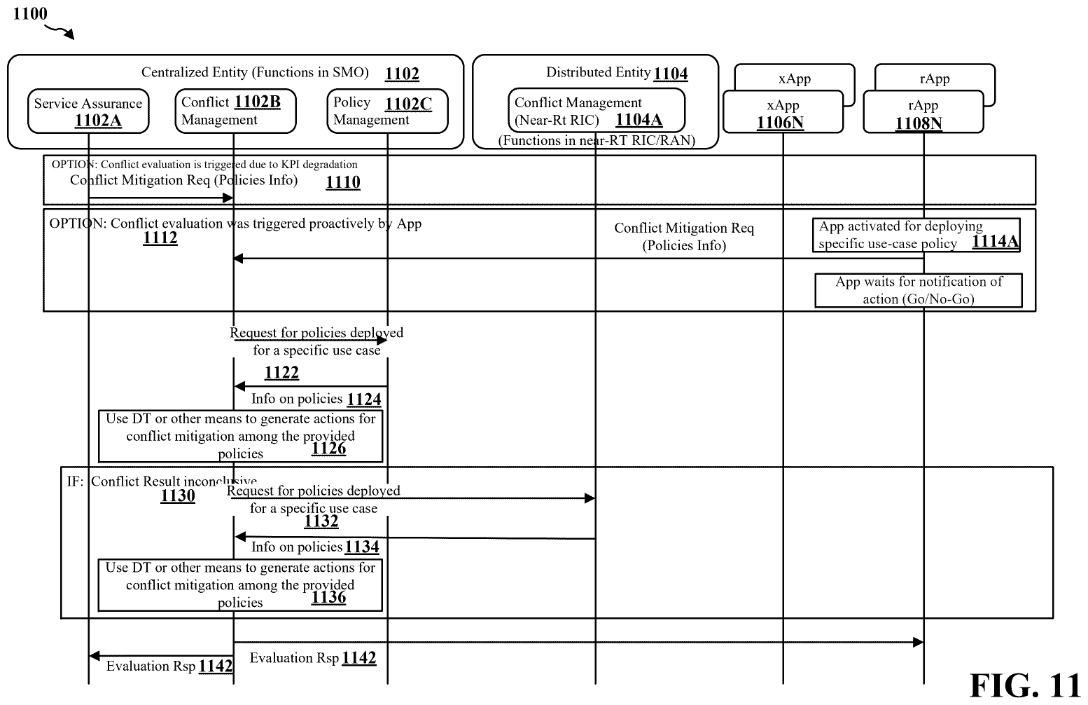

FIG. 11 is a diagram 1100 illustrating example communications between a centralized entity, a distributed entity, and one or more applications, in accordance with various aspects of the present disclosure. As illustrated in FIG. 11, a centralized entity 1102 may include a service assurance function 1102A, a conflict management function 1102B, and a policy management function 1102C. A distributed entity 1204 may include a conflict management function 1104A at near-RT RIC. There may be at least one 1108N and at least one xAPP 1106N. At 1110, if conflict evaluation is triggered due to KPI degradation (e.g., KPI Degradation for specific use-case), the service assurance function 1102A may provide conflict evaluation request to the conflict management function 1102B. At 1112, if conflict evaluation is triggered proactively by App based on the at least one rAPP 1108N being activated for deploying specific use-case policy at 1114A, the at least one rAPP 1108N may provide conflict mitigation request with policy information to the conflict management function 1102B. In some aspects, the conflict management function 1102B may provide a request for policies deployed for a specific use-case 1122 and receive information on the policies 1124 from the policy management function 1102C. At 1126, the conflict management function 1102B may use DT or other means to detect conflict among the provided policies.

At 1130, if conflict evaluation result is inconclusive, the conflict management function 1102B may provide a request for policies deployed for a specific use-case 1132 and receive information on the policies 1134 from the distributed entity 1104. At 1136, the conflict management function 1102B may use DT or other means to detect conflict among the provided policies. If conflict evaluation result is conclusive, the conflict management function 1102B may provide the evaluation response 1142 to the entity that originally sent the conflict mitigation request.

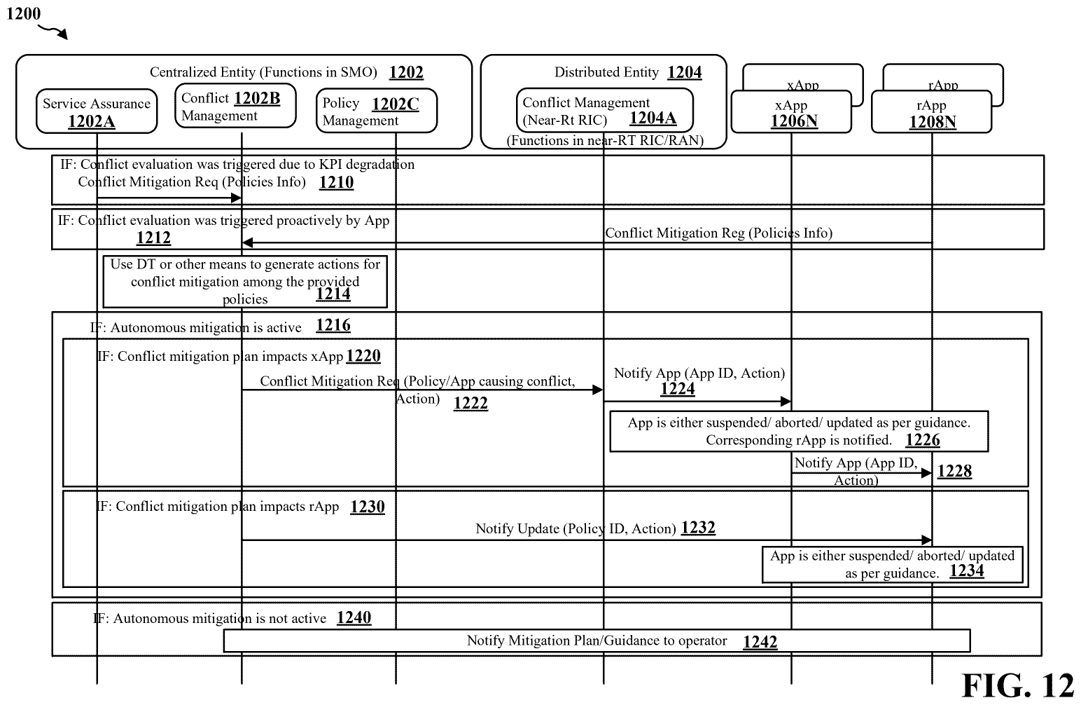

FIG. 12 is a diagram 1200 illustrating example communications between a centralized entity, a distributed entity, and one or more applications, in accordance with various aspects of the present disclosure. As illustrated in FIG. 12, a centralized entity 1202 may include a service assurance function 1202A, a conflict management function 1202B, and a policy management function 1202C. A distributed entity 1204 may include a conflict management function 1204A at near-RT RIC. There may be at least one 1208N and at least one xAPP 1206N. At 1210, if conflict evaluation is triggered due to KPI degradation (e.g., KPI Degradation for specific use-case), the service assurance function 1202A may provide conflict evaluation request to the conflict management function 1202B. At 1212, if conflict evaluation is triggered proactively by App based on the at least one rAPP 1208N being activated for deploying specific use-case policy at 1214A, the at least one rAPP 1208N may provide conflict mitigation request with policy information to the conflict management function 1202B. At 1214, the conflict management function 1202B may use DT or other means to detect conflict among the provided policies. If autonomous mitigation is active (1216), if the conflict mitigation plan impacts xApp (1220), the conflict management function 1202B may provide conflict mitigation request 1222 (which includes information regarding policy/App causing conflict action) to the conflict management function 1204A, which may in turn notify the at least one xAPP 1206N at 1224. At 1226, the at least one xAPP 1206N either suspended/aborted/updated as per guidance, and may notify corresponding rApp at 1228. If conflict mitigation plan impacts rApp (1230), the conflict management function 1202B may notify update (includes policy ID and action) 1232 for the at least one rAPP 1208N and the App may suspend/abort/update per guidance at 1234. In some aspects, if autonomous mitigation is not active (1240), the conflict management function 1202B may notify mitigation plan/guidance to operator at 1242.

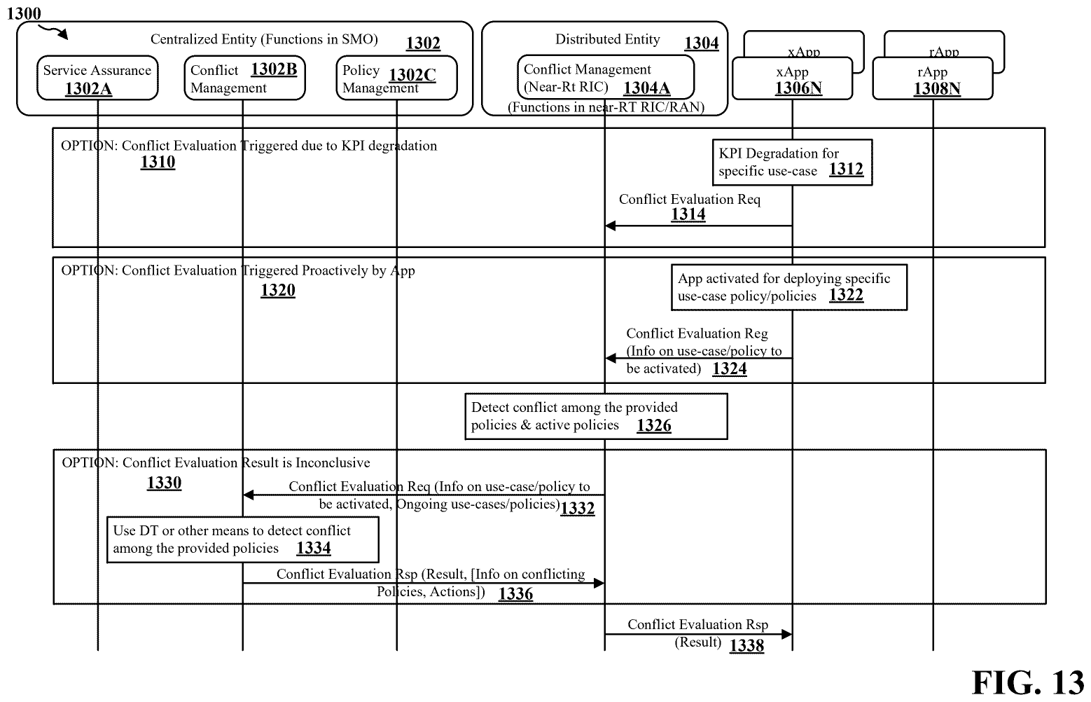

FIG. 13 is a diagram 1300 illustrating example communications between a centralized entity, a distributed entity, and one or more applications, in accordance with various aspects of the present disclosure. As illustrated in FIG. 13, a centralized entity 1302 may include a service assurance function 1302A, a conflict management function 1302B, and a policy management function 1302C. A distributed entity 1304 may include a conflict management function 1304A at near-RT RIC. There may be at least one 1308N and at least one xAPP 1306N. At 1310, if conflict evaluation triggered due to KPI degradation (e.g., KPI Degradation for specific use-case for the at least one xAPP 1306N at 1312), the conflict management function 1304A may receive a conflict evaluation request 1314 from the at least one xAPP 1306N. At 1320, if conflict evaluation is triggered proactively by App, such as due to the at least one xApp 1306N being activated for deploying specific use-case policy/policies at 1322, the conflict management function 1304A may receive a conflict evaluation request 1324 from the at least one xAPP 1306N which includes information on use-case/policy to be activated. The conflict management function 1304A may, at 1326, detect conflict among the provided policies & active policies. If the conflict evaluation result is inconclusive (1330), the conflict management function 1304A may provide a conflict evaluation request 1332 (which includes information on use-case/policy to be activated, ongoing use-cases/policies, or the like) to the conflict management function 1302B. The conflict management function 1302B may, at 1334, use DT or other means to detect conflict among the provided policies and provide conflict evaluation response 1336 (which may include result such as information on conflicting policies, actions, or the like), back to the conflict management function 1304A. The conflict management function 1304A may in turn transmit conflict evaluation response 1338 back to the at least one xApp 1306N based on the received response.

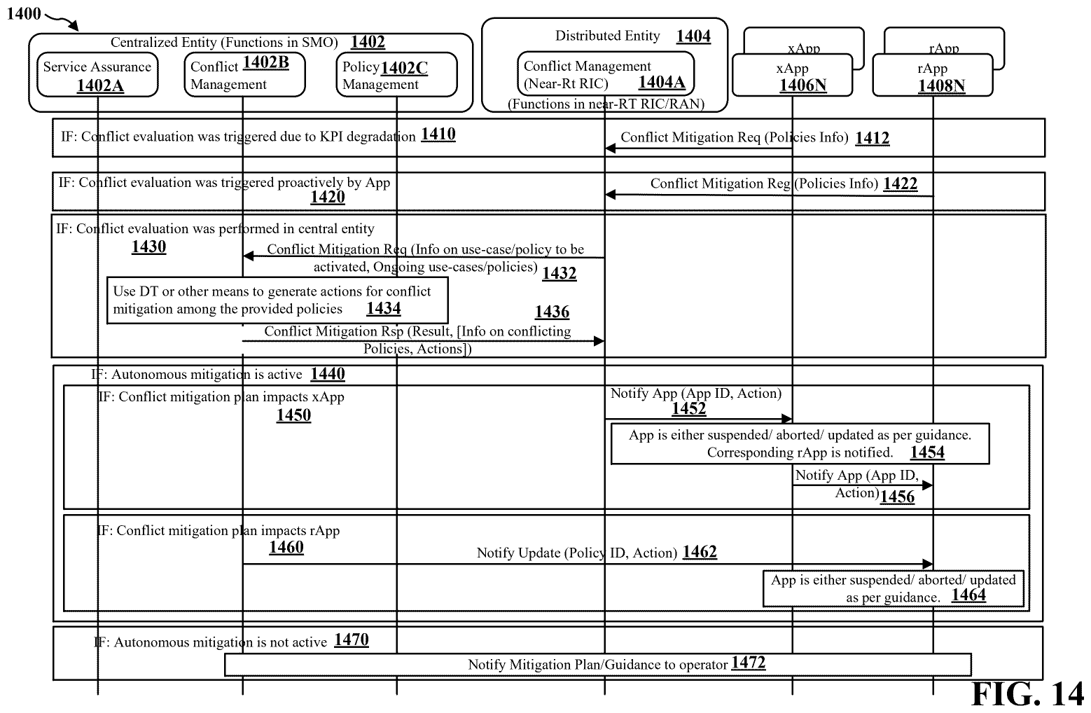

FIG. 14 is a diagram 1400 illustrating example communications between a centralized entity, a distributed entity, and one or more applications, in accordance with various aspects of the present disclosure. As illustrated in FIG. 14, a centralized entity 1402 may include a service assurance function 1402A, a conflict management function 1402B, and a policy management function 1402C. A distributed entity 1404 may include a conflict management function 1404A at near-RT RIC. There may be at least one 1408N and at least one xAPP 1406N. At 1410, if conflict evaluation triggered due to KPI degradation (e.g., KPI Degradation for specific use-case for the at least one xAPP 1406N), the conflict management function 1404A may receive a conflict evaluation request 1412 from the at least one xAPP 1406N. At 1420, if conflict evaluation is triggered proactively by App, such as due to the at least one xApp 1406N being activated for deploying specific use-case policy/policies, the conflict management function 1404A may receive a conflict evaluation request 1422 from the at least one xAPP 1406N which includes information on use-case/policy to be activated. If conflict evaluation was performed in central entity, at 1430, the conflict management function 1404A may transmit conflict mitigation request 1432 to the conflict management function 1402B, which may use DT or other means to generate actions for conflict mitigation among the provided policies at 1434, and respond with conflict mitigation response 1436. If autonomous mitigation is active (e.g., 1440), if conflict mitigation plan impacts xApp (1450), the conflict management function 1404A may notify the at least one xAPP 1406N at 1452. The at least one xAPP 1406N may cither suspended/aborted/updated as per guidance at 1454 and notify corresponding rApp at 1456. If conflict mitigation plan impacts rApp (1460), the conflict management function 1402B may notify the at least one rAPP 1408N at 1462. The rApp may suspend/abort/update per guidance at 1464. In some aspects, if autonomous mitigation is not active (1470), the conflict management function 1202B may notify mitigation plan/guidance to operator at 1472.

In summary, conflict detection may be triggered by centralized entity. Conflict management service within the centralized entity may get a dump of deployed policies pertaining to a specific use-case or a functionality. Conflict Management service could use DT or other algorithms to detect conflict among the policies. If the result is not conclusive, the service could check with distributed system to provide dump of policies pertaining to a specific use-case or a functionality. Conflict management service retriggers the conflict detection among the policies deployed via centralized and distributed entities. If the conflict management service detects a policy creating the impacts, the service may further trigger conflict resolution. As part of conflict resolution, the service may provide guidance or autonomously disable the conflicting policies based on the rules configured by the operator or some algorithm. Conflict management service within the Centralized entity may provide guidance or action on conflict resolution to the distributed entity. Conflict detection may also be triggered by distributed entity. Distributed System may get a policy from the centralized entity to be provided in a granular format to the RAN. The conflict management service within the distributed entity can detect a conflict between the incoming policy amongst the policies deployed via xApps to the RAN. The conflict management service may notify the conflict management service in the centralized entity on the conflicting policies and request for resolution. Alternatively, conflict management service may notify the corresponding rApps on the conflicting policies and the rApps can request for conflict resolution with the conflict management service in the centralized entity.

Conflict management function in SMO may be a centralized conflict evaluation/detection and mitigation/guidance entity. It may use both DT and non-DT (like dependency rules, AI/ML models, past knowledge) to perform conflict detection and mitigation. Conflict management functions may be invoked by rApps, KPI monitoring service, Configuration management service, near-RT RIC platform/xApps, policy management & information service, or RAN nodes. The trigger may be either pre-deployment or post-deployment of the policy/configuration. KPI monitoring service can be realized either as an extension of “Service & Subnet Slice Assurance” or another function which monitors performance/fault data corresponding to deployed policies/configurations and evaluates them against set expectations. policy management and information service manages all the policy/application related information for conflict management. Conflict management function's recommendation for mitigation is either deployed directly by revoking problem Apps or can be presented as guidance to consumers of the service for further actions. Information of candidate xApp configurations for conflict evaluation/detection and mitigation commands/guidance can be exchanged between near-RT RIC Platform (nearRtRicConflictMitFn) and SMO conflict management function. Conflict management related DT services are exposed to consumers via SME. Conflict management can also be implemented as a distributed framework. Near-RT RIC platform (nearRtRicConflictMitFn) may manage all xApp related information and conflicts locally. Occasionally (for indirect/implicit conflict type) it avails conflict management related DT services from SMO. Similarly, Conflict Management in SMO may manage rApp related conflicts locally, by using DT/non-DT services. In some cases, (when some xApp generated policy is suspected to be cause of conflict) gets information about xApp from Near-RT RIC Platform (nearRtRicConflictMitFn) for conflict detection/mitigation.

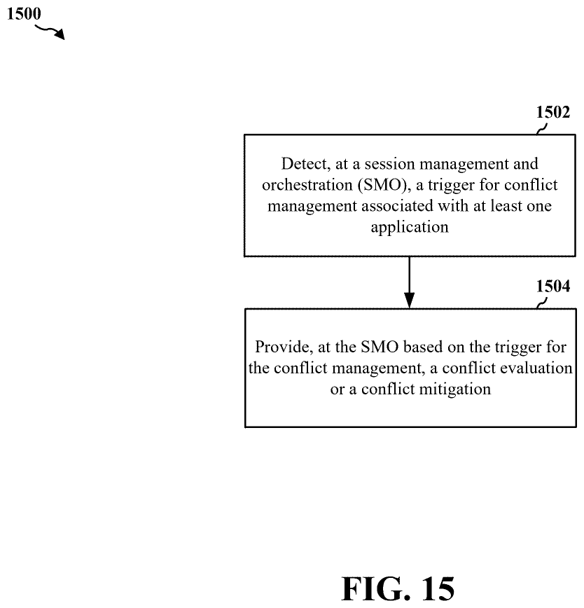

FIG. 15 is a flowchart 1500 of a method of wireless communication. The method may be performed by a network entity (e.g., the base station 102, the centralized entity 1102, 1202, 1302, or 1402, the network entity 1660). The method may enable an SMO to provide conflict mitigation or evaluation for different applications to resolve current or potential conflict of policy or configuration of applications.

At 1502, the network entity may detect, at a session management and orchestration (SMO), a trigger for conflict management associated with at least one application. For example, the network entity (e.g., 1102, 1202, 1302, 1402) may detect, at a session management and orchestration (SMO), a trigger for conflict management associated with at least one application. In some aspects, 1502 may be performed by conflict component 199.

At 1504, the network entity may provide, at the SMO based on the trigger for the conflict management, a conflict evaluation or a conflict mitigation. For example, the network entity (e.g., 1102, 1202, 1302, 1402) may provide, at the SMO based on the trigger for the conflict management, a conflict evaluation or a conflict mitigation. In some aspects, 1504 may be performed by conflict component 199.

In some aspects, the trigger is an app initiated conflict evaluation associated with the at least one application, and where the app initiated conflict evaluation is before a deployment of at least one policy associated with the conflict management. In some aspects, the detection is based on a non-digital twin (non-DT) technique corresponding to at least one of: at least one dependency rule, at least one artificial intelligence (AI)/machine learning (ML) (AI/ML) model, or at least one conflict record associated with the at least one application. In some aspects, the detection is based on a digital twin (DT) associated with the at least one application that simulates at least one conflict associated with the at least one application. In some aspects, the trigger is an application-initiated conflict evaluation associated with the at least one application, and where the app initiated conflict evaluation is after a deployment of at least one policy associated with the conflict management. In some aspects, the trigger is based on a key performance indicator (KPI) degradation associated with the at least one application, and the network entity may receive an indication of the KPI degradation from a KPI monitoring service, a configuration management service, a policy management and information service, a near-real time radio access network intelligent controller (near-RT RIC) platform, a network node, or the at least one application.

In some aspects, the network entity may provide the conflict mitigation, and the conflict mitigation corresponds to a revocation of at least one policy or at least one configuration associated with the at least one application. In some aspects, the network entity may provide the conflict mitigation, and where the conflict mitigation corresponds to a guidance to a network operation and management entity. In some aspects, the network entity may receive, at the SMO from a near-real time radio access network intelligent controller (near-RT RIC) platform, a candidate configuration or a candidate policy associated with the conflict management. In some aspects, the network entity may transmit, via a service management and exposure (SME), an indication of a service for the conflict management. In some aspects, to provide the conflict evaluation or the conflict mitigation, the network entity may provide, to a near-real time radio access network intelligent controller (near-RT RIC) platform responsible for the conflict management associated with the at least one application, the conflict evaluation or the conflict mitigation, where the at least one application corresponds to at least one near-real-time RIC Application (xAPP) configured to run on the near-RT RIC platform. In some aspects, the network entity may deploy the conflict mitigation, where the at least one application is configured to corresponds to at least one non-real-time radio access network intelligent controller (RIC) Application (rAPP). In some aspects, the network entity may detect at least one conflict associated with the at least one application based on performance of a set of iterative simulations based on a digital twin (DT) associated with the at least one application with a configuration of a respective policy against a set of policies associated with the at least one application. In some aspects, the network entity may detect at least one conflict associated with the at least one application based on selection of a set of conflict policies associated with the at least one application. In some aspects, the network entity may detect at least one conflict associated with the at least one application based on a rule specified in an operator configuration associated with the at least one application. In some aspects, the network entity may provide the conflict evaluation, where the conflict evaluation includes information of a set of conflict policies associated with the at least one application. In some aspects, the trigger is originated within the SMO. In some aspects, the trigger is originated from at least one entity within a near-real time radio access network intelligent controller (near-RT RIC) platform.

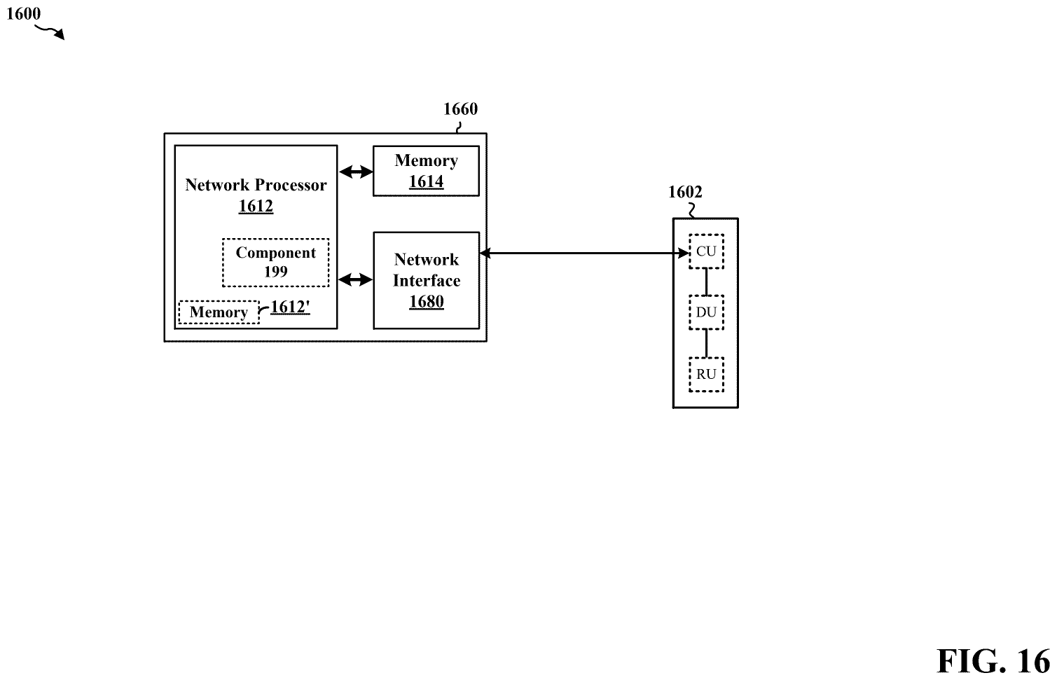

FIG. 16 is a diagram 1600 illustrating an example of a hardware implementation for a network entity 1660. In one example, the network entity 1660 may be within the core network 120. The network entity 1660 may include at least one network processor 1612. The network processor(s) 1612 may include on-chip memory 1612′. In some aspects, the network entity 1660 may further include additional memory modules 1614. The network entity 1660 communicates via the network interface 1680 directly (e.g., backhaul link) or indirectly (e.g., through a RIC) with the CU 1602. The on-chip memory 1612′ and the additional memory modules 1614 may each be considered a computer-readable medium/memory. Each computer-readable medium/memory may be non-transitory. The network processor(s) 1612 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the conflict component 199 may be configured to detect, at a session management and orchestration (SMO), a trigger for conflict management associated with at least one application. In some aspects, the conflict component 199 may be further configured to provide, at the SMO based on the trigger for the conflict management, a conflict evaluation or a conflict mitigation. The component 199 may be within the network processor(s) 1612. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1660 may include a variety of components configured for various functions. In some aspects, the network entity 1660 may include means for detecting, at a session management and orchestration (SMO), a trigger for conflict management associated with at least one application. In some aspects, the network entity 1660 may include means for providing, at the SMO based on the trigger for the conflict management, a conflict evaluation or a conflict mitigation. In some aspects, the network entity 1660 may include means for receiving an indication of the KPI degradation from a KPI monitoring service, a configuration management service, a policy management and information service, a near-real time radio access network intelligent controller (near-RT RIC) platform, a network node, or the at least one application. In some aspects, the network entity 1660 may include means for receiving, at the SMO from a near-real time radio access network intelligent controller (near-RT RIC) platform, a candidate configuration or a candidate policy associated with the conflict management. In some aspects, the network entity 1660 may include means for transmitting, via a service management and exposure (SME), an indication of a service for the conflict management. In some aspects, the network entity 1660 may include means for providing, to a near-real time radio access network intelligent controller (near-RT RIC) platform responsible for the conflict management associated with the at least one application, the conflict evaluation or the conflict mitigation, where the at least one application corresponds to at least one near-real-time RIC Application (xApp) configured to run on the near-RT RIC platform. In some aspects, the network entity 1660 may include means for deploying the conflict mitigation, where the at least one application is configured to corresponds to at least one non-real-time radio access network intelligent controller (RIC) Application (rApp). In some aspects, the network entity 1660 may include means for detecting at least one conflict associated with the at least one application based on performance of a set of iterative simulations based on a digital twin (DT) associated with the at least one application with a configuration of a respective policy against a set of policies associated with the at least one application. In some aspects, the network entity 1660 may include means for detecting at least one conflict associated with the at least one application based on selection of a set of conflict policies associated with the at least one application. In some aspects, the network entity 1660 may include means for detecting at least one conflict associated with the at least one application based on a rule specified in an operator configuration associated with the at least one application. In some aspects, the network entity 1660 may include means for providing the conflict evaluation, where the conflict evaluation includes information of a set of conflict policies associated with the at least one application. The means may be the component 199 of the network entity 1660 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for wireless communication at a network entity, including: at least one memory; and at least one processor coupled to the at least one memory, based at least in part on stored information that is stored in the at least one memory, the at least one processor, individually or in any combination, is configured to cause the network entity to: detect, at a session management and orchestration (SMO), a trigger for conflict management associated with at least one application; and provide, at the SMO based on the trigger for the conflict management, a conflict evaluation or a conflict mitigation.

Aspect 2 is the apparatus of aspect 1, where the trigger is an app initiated conflict evaluation associated with the at least one application, and where the app initiated conflict evaluation is before a deployment of at least one policy associated with the conflict management.

Aspect 3 is the apparatus of any of aspects 1-2, where a detection of the trigger is based on a non-digital twin (non-DT) technique corresponding to at least one of: at least one dependency rule, at least one artificial intelligence (AI)/machine learning (ML)(AI/ML) model, or at least one conflict record associated with the at least one application.

Aspect 4 is the apparatus of any of aspects 1-2, where a detection of the trigger is based on a digital twin (DT) associated with the at least one application that simulates at least one conflict associated with the at least one application.

Aspect 5 is the apparatus of any of aspects 1-4, where the trigger is an application-initiated conflict evaluation associated with the at least one application, and where the application-initiated conflict evaluation is after a deployment of at least one policy associated with the conflict management.

Aspect 6 is the apparatus of any of aspects 1-5, where the trigger is based on a key performance indicator (KPI) degradation associated with the at least one application, and where the at least one processor is further configured to: receive an indication of the KPI degradation from a KPI monitoring service, a configuration management service, a policy management and information service, a near-real time radio access network intelligent controller (near-RT RIC) platform, a network node, or the at least one application.

Aspect 7 is the apparatus of any of aspects 1-6, where the at least one processor is configured to provide the conflict mitigation, and where the conflict mitigation corresponds to a revocation of at least one policy or at least one configuration associated with the at least one application.

Aspect 8 is the apparatus of any of aspects 1-7, where the at least one processor is configured to provide the conflict mitigation, and where the conflict mitigation corresponds to a guidance to a network operation and management entity.

Aspect 9 is the apparatus of any of aspects 1-8, where the at least one processor is further configured to: receive, at the SMO from a near-real time radio access network intelligent controller (near-RT RIC) platform, a candidate configuration or a candidate policy associated with the conflict management.

Aspect 10 is the apparatus of any of aspects 1-9, where the at least one processor is further configured to: transmit, via a service management and exposure (SME), an indication of a service for the conflict management.

Aspect 11 is the apparatus of any of aspects 1-10, where to provide the conflict evaluation or the conflict mitigation, the at least one processor is configured to: provide, to a near-real time radio access network intelligent controller (near-RT RIC) platform responsible for the conflict management associated with the at least one application, the conflict evaluation or the conflict mitigation, where the at least one application corresponds to at least one near-real-time RIC Application (xApp) configured to run on the near-RT RIC platform.

Aspect 12 is the apparatus of any of aspects 1-11, where the at least one processor is further configured to: deploy the conflict mitigation, where the at least one application is configured to corresponds to at least one non-real-time radio access network intelligent controller (RIC) Application (rApp).

Aspect 13 is the apparatus of any of aspects 1-12, where to provide the conflict evaluation or the conflict mitigation, the at least one processor is configured to: detect at least one conflict associated with the at least one application based on performance of a set of iterative simulations based on a digital twin (DT) associated with the at least one application with a configuration of a respective policy against a set of policies associated with the at least one application.

Aspect 14 is the apparatus of any of aspects 1-13, where to provide the conflict evaluation or the conflict mitigation, the at least one processor is configured to: detect at least one conflict associated with the at least one application based on selection of a set of conflict policies associated with the at least one application.

Aspect 15 is the apparatus of any of aspects 1-14, where to provide the conflict evaluation or the conflict mitigation, the at least one processor is configured to: detect at least one conflict associated with the at least one application based on a rule specified in an operator configuration associated with the at least one application.

Aspect 16 is the apparatus of any of aspects 1-15, where to provide the conflict evaluation or the conflict mitigation, the at least one processor is configured to: provide the conflict evaluation, where the conflict evaluation includes information of a set of conflict policies associated with the at least one application.

Aspect 17 is the apparatus of any of aspects 1-16, where the trigger is originated within the SMO.

Aspect 18 is the apparatus of any of aspects 1-16, where the trigger is originated from at least one entity within a near-real time radio access network intelligent controller (near-RT RIC) platform.

Aspect 19 is a method of wireless communication for implementing any of aspects 1 to 18.

Aspect 20 is a computer-readable medium (e.g., a non-transitory computer-readable medium) storing computer executable code, the code when executed by at least one processor causes the at least one processor to implement any of aspects 1 to 18.

Aspect 21 is an apparatus comprising means for implementing any of aspects 1 to 18.

What is claimed is:

1. An apparatus for wireless communication at a network entity, comprising:
at least one memory; and
at least one processor coupled to the at least one memory, based at least in part on stored information that is stored in the at least one memory, the at least one processor, individually or in any combination, is configured to cause the network entity to:
detect, at a session management and orchestration (SMO), a trigger for conflict management associated with at least one application; and
provide, at the SMO based on the trigger for the conflict management, a conflict evaluation or a conflict mitigation.

2. The apparatus of claim 1, wherein the trigger is an app initiated conflict evaluation associated with the at least one application, and wherein the app initiated conflict evaluation is before a deployment of at least one policy associated with the conflict management.

3. The apparatus of claim 1, wherein a detection of the trigger is based on a non-digital twin (non-DT) technique corresponding to at least one of: at least one dependency rule, at least one artificial intelligence (AI)/machine learning (ML)(AI/ML) model, or at least one conflict record associated with the at least one application.

4. The apparatus of claim 1, wherein a detection of the trigger is based on a digital twin (DT) associated with the at least one application that simulates at least one conflict associated with the at least one application.

5. The apparatus of claim 1, wherein the trigger is an application-initiated conflict evaluation associated with the at least one application, and wherein the application-initiated conflict evaluation is after a deployment of at least one policy associated with the conflict management.

6. The apparatus of claim 1, wherein the trigger is based on a key performance indicator (KPI) degradation associated with the at least one application, and wherein the at least one processor is further configured to:
receive an indication of the KPI degradation from a KPI monitoring service, a configuration management service, a policy management and information service, a near-real time radio access network intelligent controller (near-RT RIC) platform, a network node, or the at least one application.

7. The apparatus of claim 1, wherein the at least one processor is configured to provide the conflict mitigation, and wherein the conflict mitigation corresponds to a revocation of at least one policy or at least one configuration associated with the at least one application.

8. The apparatus of claim 1, wherein the at least one processor is configured to provide the conflict mitigation, and wherein the conflict mitigation corresponds to a guidance to a network operation and management entity.

9. The apparatus of claim 1, wherein the at least one processor is further configured to:
receive, at the SMO from a near-real time radio access network intelligent controller (near-RT RIC) platform, a candidate configuration or a candidate policy associated with the conflict management.

10. The apparatus of claim 1, wherein the at least one processor is further configured to:
transmit, via a service management and exposure (SME), an indication of a service for the conflict management.

11. The apparatus of claim 1, wherein to provide the conflict evaluation or the conflict mitigation, the at least one processor is configured to:
provide, to a near-real time radio access network intelligent controller (near-RT RIC) platform responsible for the conflict management associated with the at least one application, the conflict evaluation or the conflict mitigation, wherein the at least one application corresponds to at least one near-real-time RIC Application (xApp) configured to run on the near-RT RIC platform.

12. The apparatus of claim 1, wherein the at least one processor is further configured to:
deploy the conflict mitigation, wherein the at least one application is configured to corresponds to at least one non-real-time radio access network intelligent controller (RIC) Application (rApp).

13. The apparatus of claim 1, wherein to provide the conflict evaluation or the conflict mitigation, the at least one processor is configured to:
detect at least one conflict associated with the at least one application based on performance of a set of iterative simulations based on a digital twin (DT) associated with the at least one application with a configuration of a respective policy against a set of policies associated with the at least one application.

14. The apparatus of claim 1, wherein to provide the conflict evaluation or the conflict mitigation, the at least one processor is configured to:
detect at least one conflict associated with the at least one application based on selection of a set of conflict policies associated with the at least one application.

15. The apparatus of claim 1, wherein to provide the conflict evaluation or the conflict mitigation, the at least one processor is configured to:
detect at least one conflict associated with the at least one application based on a rule specified in an operator configuration associated with the at least one application.

16. The apparatus of claim 1, wherein to provide the conflict evaluation or the conflict mitigation, the at least one processor is configured to:
provide the conflict evaluation, wherein the conflict evaluation comprises information of a set of conflict policies associated with the at least one application.

17. The apparatus of claim 1, wherein the trigger is originated within the SMO.

18. The apparatus of claim 1, wherein the trigger is originated from at least one entity within a near-real time radio access network intelligent controller (near-RT RIC) platform.

19. A method for wireless communication performed by a network entity, comprising:
detecting, at a session management and orchestration (SMO), a trigger for conflict management associated with at least one application; and
providing, at the SMO based on the trigger for the conflict management, a conflict evaluation or a conflict mitigation.

20. An apparatus for wireless communication at a network entity, comprising:
means for detecting, at a session management and orchestration (SMO), a trigger for conflict management associated with at least one application; and
means for providing, at the SMO based on the trigger for the conflict management, a conflict evaluation or a conflict mitigation.
